(19) United States
(12) Patent Application Publication
(10) Pub. No.: US 2024/0406214 A1
(43) Pub. Date: Dec. 5, 2024

(54) CONSISTENT RULE-BASED POLICY ENFORCEMENT FOR ACCESS AUTHORIZATION

(71) Applicant: Veza Technologies, Inc., Los Gatos, CA (US)

(72) Inventors: Maohua Lu, Fremont, CA (US); Tarun Thakur, Los Gatos, CA (US); Robert Whitcher, Erie, CO (US)

(21) Appl. No.: 18/680,379

(22) Filed: May 31, 2024

Related U.S. Application Data
(60) Provisional application No. 63/505,292, filed on May 31, 2023.

(51) Int. Cl. H04L 9/40; G06F 21/62

(52) U.S. Cl. CPC H04L 63/20; G06F 21/6218

(57) ABSTRACT

The technology disclosed herein enables control of permissions to access resources of data environments based on business requirements. In a particular example, a method provides determining a high-level requirement for access to data environments and defining an access policy that maps to the high-level requirement. The method further provides generating one or more rules to implement the access policy and enforcing the rules on access requests to the data environments to satisfy the high-level requirement.

### RELATED APPLICATIONS

This application is related to and claims priority to U.S. Provisional Patent Application 63/505,292, titled “CONSISTENT RULE-BASED POLICY ENFORCEMENT FOR ACCESS AUTHORIZATION,” filed May 31, 2023, and which is hereby incorporated by reference in its entirety.

### TECHNICAL BACKGROUND

Modern enterprises use numerous data environments to store, manage, and/or process data and those environments may be managed by different systems, applications, and/or platforms from different providers and each may use its own data repository (e.g., database). For instance, different departments may employ different database systems depending on the features offered by the respective system (e.g., accounting may use a first database system while human resources uses a second). In some cases, a single department may itself use multiple platforms for data repositories depending on the capabilities of each platform even if the platforms manage similar data sets. For example, human resources may use one platform to onboard and terminate employees from the enterprise while another platform is used to handle employees' compensation and benefits. Even though identity environments, such as IAM and Okta, may be employed to manage user identities and access, it can still be difficult to ensure an overarching business requirement is properly implemented across all data environments and users.

### SUMMARY

The technology disclosed herein enables control of permissions to access resources of data environments based on high-level requirements. In a particular example, a method provides determining a high-level requirement for access to data environments and defining an access policy that maps to the high-level requirement. The method further provides generating one or more rules to implement the access policy and enforcing the rules on access requests to the data environments to satisfy the high-level requirement.

In another example, an apparatus is provided having one or more computer readable storage media and a processing system operatively coupled with the one or more computer readable storage media. Program instructions stored on the one or more computer readable storage media, when read and executed by the processing system, direct the apparatus to perform the steps of the above-recited method.

### BRIEF DESCRIPTION OF THE DRAWINGS

FIG. 1 illustrates an implementation for controlling permissions to access resources based on high-level requirements.

FIG. 2 illustrates an operation to control permissions to access resources based on high-level requirements.

FIG. 3 illustrates an operational scenario for controlling permissions to access resources based on high-level requirements.

FIG. 4 illustrates an operation to control permissions to access resources based on high-level requirements.

FIG. 5 illustrates an operation to control permissions to access resources based on high-level requirements.

FIG. 6 illustrates an operation to control permissions to access resources based on high-level requirements.

FIG. 7 illustrates an operation to control permissions to access resources based on high-level requirements.

FIG. 8 illustrates a computing architecture for controlling permissions to access resources based on high-level requirements.

### DETAILED DESCRIPTION

The rule and policy engine described herein automates Identity Governance and Administration (IGA) by mapping business requirements to enforceable policies and rules across data environments used by a business. A business requirement indicates, in a general sense, which users (e.g., employees, contractors, etc.) should have access to which resources of the data environments. A business requirement may exist to ensure compliance with regulatory schemes, information security needs, or some other type of compliance that may affect a business' operations. For example, a business requirement may be employees located outside of the United States cannot access financial data. The rule and policy engine converts that business into one or more policies/rules that effect the requirement in the data environments of the business. While referred to herein as a business requirement since business requirements art often the impetus for access policies, the high-level nature of the rule may be associated with other types of requirements (e.g., those for educational institutions or other types of entities).

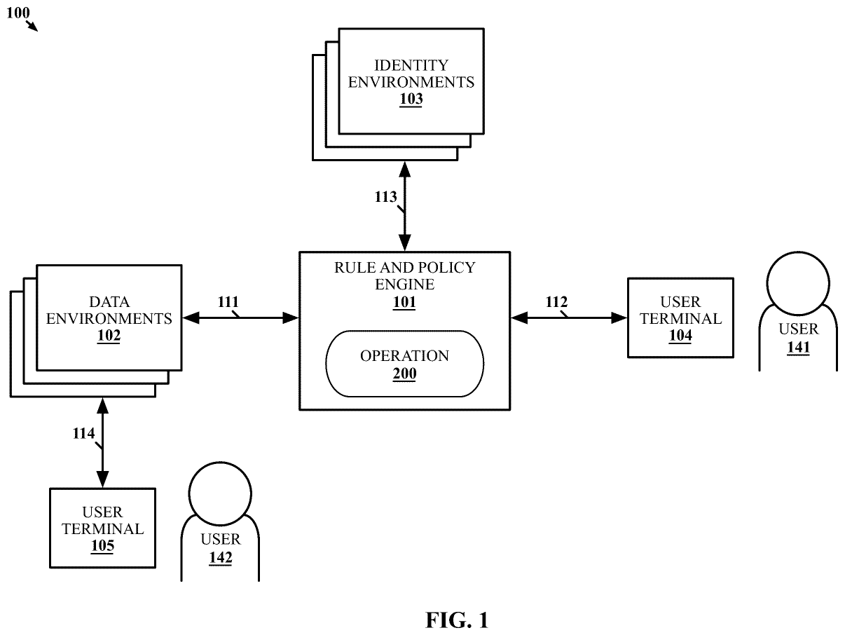

FIG. 1 illustrates implementation 100 for controlling permissions to access resources based on high-level requirements. Implementation 100 includes rule and policy engine 101, data environments 102, identity environments 103, user terminal 104, and user terminal 105. Rule and policy engine 101 and data environments 102 communicate over respective communication links 111. Rule and policy engine 101 and user terminal 104 communicate over communication link 112. Rule and policy engine 101 and user terminal 105 communicate over communication link 114. Rule and policy engine 101 and identity environments 103 communicate over respective communication links 113. While communication links 111-114 are shown as direct links, communication links 111-113 may include intervening systems, networks, and/or devices. Rule and policy engine 101 executes on one or more computing systems, such as server systems, having processing and communication circuitry to operate as described below. User terminals 104 and 105 are each a user operated computing system, such as a desktop workstation, laptop, tablet computer, smartphone, etc.

In operation, rule and policy engine 101 performs operation 200 to generate rules for implementation across identity environments 103 and data environments 102 to ensure business requirements are enforced in data environments 102. Data environments 102 include one or more systems that host databases, such as databases for Online Transaction Processing (OLTP) and Online Analytical Processing (OLAP), tables, files, applications, or other computing resources provided to accessing systems—including combinations thereof. Identity environments 103 include one or more systems that maintain information about users (e.g., user identity information, user attributes, etc.) and information about which of data environments 102 (including specific data/features therein) each user is allowed to access. Identity environments 103 may include an active directory (AD) server, an Okta® system, an Identity and Access Management (IAM) system, a privilege access management (PAM) system, human resources management system (HRMS), identity and access governance (IAG) system, or any other type of system that maintains the user information discussed above. Identity environments 103 maintain identity information about users that may access one or more of data environments 102. The identity information may include authorization information indicating whether given users are allowed to access particular resources provided by data environments 102 or ones of data environments 102 as a whole. In some examples, a data environment of data environments 102 may authorize a user itself based on identity information for the user included in identity environments 103. For instance, identity environments 103 may indicate information about a user, such as a work group for the user, the user's job title/role, a seniority of the user, a security clearance level for the user, or any other type of information that may affect which of data environments 102 the user can access. In further examples, a data environment of data environments 102 may authorize users independently.

Regardless of the arrangement between data environments 102 and identity environments 103 to determine access privileges of users, rules are implemented by the environments to define which users have access to which resources of data environments 102. The rules may indicate which users have access to which resources or may indicate which users do not have access to which resources. The rules may further indicate specific activities that a user is able, or is not able, to perform with a particular resource rather than a blanket allowance or denial of access. For example, a rule may indicate whether a user is allowed data read, data write, metadata read, metadata write, and non-data access—including combinations thereof. The rules can, therefore, be used to enforce a business requirement regarding access to data environments 102 and rule and policy engine 101 ensures the appropriate rules are in place to enforce that business requirement.

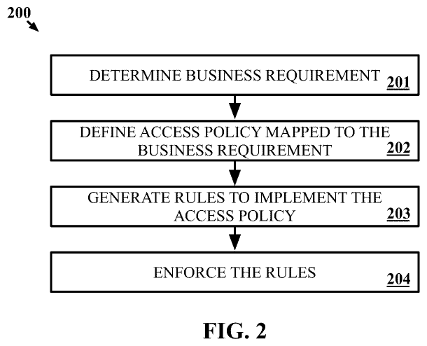

FIG. 2 illustrates operation 200 to control permissions to access resources based on high-level requirements. In operation 200, rule and policy engine 101 determines a business requirement for access to data environments 102 (step 201). The business requirement may be defined from a guardrail perspective or an allowed-activity perspective. Guardrail requirements are those business requirements that indicate activity that cannot occur in data environments 102. For instance, a business requirement that users located outside a particular geographic area cannot access financial information in data environments 102 is a guardrail requirement because it is guarding against undesired access outside of the area. Allowed-activity requirements are those business requirements that indicate activity that is allowed to occur in data environments 102. For example, a business requirement that users in the financial workgroup can access financial information in data environments 102 is an allowed-activity requirement. The business requirement in this example may be received from user terminal 104. For instance, user 141 may be an administrator in charge of data environments 102 for the business and may enter the business requirement into user terminal 104 (e.g., via an interface to rule and policy engine 101 executing on user terminal 104). It should be understood that, while the examples herein refer to business requirements, the other types of entities, such as educational institutions, also use environments like data environments 102 and identity environments 103. Those entities may also have high-level rules (e.g., business requirements) that can be implemented by rule and policy engine 101 as described herein.

Rule and policy engine 101 defines an access policy that maps to the business requirement (step 202). The access policy is defined relative to the specific systems and resources of data environments 102. For example, while a business requirement may define “financial information,” the access policy defines specific resources of data environments 102 that contain financial information (e.g., specific databases or entire environments). Rule and policy engine 101 may track resources of data environments 102 or receive information about the resources to determine attributes of the resources (e.g., the type of information contained in the resource). From the access policy, rule and policy engine 101 generates one or more rules to implement the access policy (step 203). In some cases, a single rule may be able to implement the access policy. However, in many cases, multiple rules may be required to implement the access policy. For example, different ones of data environments 102 may use different ones of identity environments 103. A different rule may be necessary to account for each of the identity environments 103 (e.g., different formatting or conventions used by the respective environments). For instance, a first of identity environments 103 may identify users in one manner (e.g., by unique user number) while a second of identity environments 103 may identify users in another manner (e.g., by username).

Rule and policy engine 101 enforces the rules on access requests to the data environments to satisfy the business requirement (step 204). To enforce the rules, rule and policy engine 101 may transmit respective rules to the corresponding ones of data environments 102 and/or identity environments 103 that will apply the rules. In some examples, identity environments will handle all authorizations and, therefore, receive the rules from rule and policy engine 101 while, in some other examples, data environments handle at least a portion of the authorizations and implement rules independently of an identity environment. When a new access request (e.g., to read or write data) is received from user terminal 105 by one of data environments 102, the receiving data environment, or an identity environment associated with the data environment, applies one of the rules from rule and policy engine 101 (in addition to other existing rules) to determine whether the access request associated with user 142 is allowed. If the rule indicates that user 142 is allowed access, then a response to the access request allows access. If the rule indicates that user 142 is not allowed access, then a response to the access request denies access.

In some examples, the rules generated by rule and policy engine 101 may not be enforced immediately. Instead, the rules may go through a lifecycle to ensure rule and policy engine 101 has generated rules that will not adversely affect operations of data environments 102. The lifecycle may include five stages. A proposed stage, an informational stage, an alerting stage, a recommendation stage, and then an auto-enforced stage. Other examples may use fewer stages than the five described (e.g., the alerting stage may be skipped). When in the proposed stage, rule and policy engine 101 proposes the rules to user 141 via user terminal 104. By first proposing the rules, user 141 can identify any glaring issues the rules may have (e.g., may determine that a resource has been misidentified as being covered by the business requirement). Upon user 141 approving moving to the informational stage, rule and policy engine 101 begins tracking when an access request is received to which one of the rules would apply if enforced. Rule and policy engine 101 can then provide information about the access requests to user 141. For instance, the information may include details about the access requests and whether a response to the access request (e.g., access allowance or denial) would have changed had the rules been in force.

If user 141 is satisfied with the information received from rule and policy engine 101, user 141 may direct rule and policy engine 101 to move the rules to the alerting stage. In the alerting stage, rule and policy engine 101 may alert user 141 each time one of the rules would have been triggered by an access request. The alerts may be provided while still collecting information like in the information stage. In some cases, rather than simply notifying user 141, the alerts may allow user 141 to direct rule and policy engine 101 to go ahead with enforcing the rule on the access request that triggered the alert. Subsequent to the alerting stage, the rules move to the recommendation stage where rule and policy engine 101 recommends to data environments 102 whether to start automatically enforcing the rules. The recommendation may be based on feedback received from user 141 during the informational and alerting stages and/or may be based on rule and policy engine 101's own determinations. For instance, rule and policy engine 101 may compare the performance of the rules to the performance of other rules already in force. If the performance is similar, then rule and policy engine 101 may recommend that the new rules be auto-enforced as well. Upon user 141 indicating to rule and policy engine 101 that the rules are ready for auto-enforcement, rule and policy engine 101 implements enforcement of the rules as discussed above in step 204.

The lifecycle may apply to policies rather than the rules that make up the policies. As such, user 141 may be able to determine whether a policy as a whole should be auto enforced through the discussed lifecycle stages rather than looking directly at the rules of the policy.

It should be understood that, while human users are described in the examples above, users accessing data environments 102 may include non-human users, such as systems, applications, micro-services, etc., or some combination thereof.

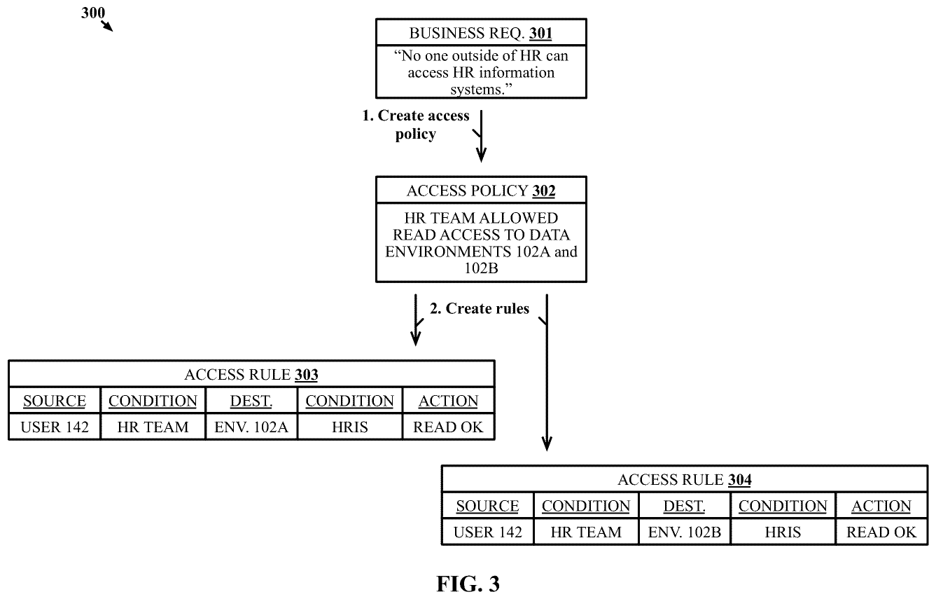

FIG. 3 illustrates operational scenario 300 for controlling permissions to access resources based on high-level requirements. Operational scenario 300 is an example of how business requirement 301 (i.e., a high-level requirement) is enforced by rule and policy engine 101 using rules generated by rule and policy engine 101. Business requirement 301, in this example, states “no one outside of human resources (HR) can access HR information systems.” The language used for business requirement 301 is natural language that may be spoken or written by a human user. English is used in this case, although, other languages may be used. As such, a user need not be trained on a particular syntax required to draft an access rule but can, instead, describe the desired effect of the access rule(s) at a higher-level

Based on business requirement 301, rule and policy engine 101 creates access policy 302 at step 1. Rule and policy engine 101 may create access policy 302 by parsing the natural language of business requirement 301 to determine components of the language that are relevant to access policies and rules. A natural language processing algorithm may be used. Upon the processing indicating that HR information systems are relevant, rule and policy engine 101 determines that data environment 102A and data environment 102B of data environments 102 are HR information systems. Different ones of data environments 102 may be defined in rule and policy engine 101 as being systems of particular types, rule and policy engine 101 may query data environments 102 to determine which type of systems they are, or rule and policy engine 101 may determine the system type in some other manner. Similarly, when a policy applies to components of data environments 102 (e.g., datasets, applications, etc.), rule and policy engine 101 may determine which components belong to which aspects of the business (or entity) in a similar manner. Rule and policy engine 101 can then create access policy 302, which is a more specific version of business requirement 301 tailored to the specific data environment situation that rule and policy engine 101 oversees. In this case, access policy 302 states “HR team allowed read access to data environment 102A and data environment 102B.”

From access policy 302, rule and policy engine 101 creates access rule 303 and access rule 304 at step 2. Rule and policy engine 101 may create two rules because data environment 102A and data environment 102B may use different ones of identity environments 103. Thus, access rule 303 may be a rule in a format required by a first of identity environments 103 and access rule 304 may be a rule in a format required by a second of identity environments 103. Each rule indicates a source (e.g., the user requesting access), a condition of the source (e.g., a business department, workgroup, title, seniority level, or some other type of attribute describing a user), a destination (e.g., a data environment or resource of a data environment), a condition of the destination (e.g., a business department, workgroup, or other type of attribute describing the destination, and an action to be taken if an access request satisfies the rule (e.g., allow/deny read, allow/deny write, etc.). The source and destination may be considered to have a “has relation to” relationship in a query. So, when determining whether a rule should apply to an access request a query may use the source has relation to the destination as the query. In access rule 303, the source is user 142, user 142 is on the HR team, the destination is data environment 102A, and data environment 102A is an HR information system. Access rule 304 is similar to access rule 303 but the destination is data environment 102B, which is also a HR information system. While the components of access rule 303 and access rule 304 are shown similarly in operational scenario 300, it should be understood that different formats or conventions may be used for access rule 303 and access rule 304 depending on the identity environment the rule is destined for. Once access rule 303 is generated, rule and policy engine 101 may implement access rule 303 in the one of identity environments 103 that handles authorization for data environment 102A. Likewise, once access rule 304 is generated, rule and policy engine 101 may implement access rule 304 in the one of identity environments 103 that handles authorization for data environment 102B. Alternatively, before implementation, rule and policy engine 101 may enter access rule 303 and access rule 304 into a lifecycle like that described above (e.g., may propose access rule 303 and access rule 304 in accordance with the first stage of the lifecycle).

In some examples, rule and policy engine 101 may check to determine whether access rule 303 and access rule 304 conflicts with any other rules in use by data environments 102. For instance, while access rule 303 indicates that user 142 has read access to data environment 102A, another rule may deny that read access. In that case, rule and policy engine 101 will not implement access rule 303 due to the conflict. Additionally, rule and policy engine 101 may implement exceptions to a rule. For example, a user may be new to the HR team and may not yet be allowed to access data environment 102A. User 141 may direct rule and policy engine 101 to create an exception to access rule 303.

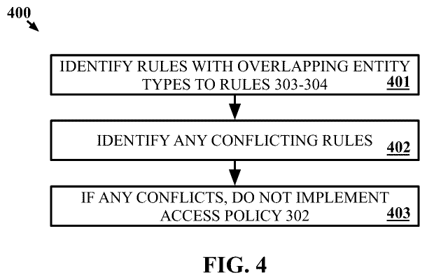

FIG. 4 illustrates operation 400 to control permissions to access resources based on high-level requirements. In operation 400, rule and policy engine 101 identifies rules with overlapping entity types to access rule 303 and access rule 304 (step 401). A rule with an overlapping entity type is a rule with a source or a destination in common with access rule 303 or access rule 304. In this specific example, access rule 303 and access rule 304 have only user 142, data environment 102A, and data environment 102B as entities. Therefore, rule and policy engine 101 is only looking for other rules having one or more of those entities.

Rule and policy engine 101 identifies conflicting rules from within the overlapping rules (step 402). For example, if another rule indicates that user 142 cannot read data environment 102A, then access rule 303 conflict with that other rule. If there are any conflicting rules, rule and policy engine 101 does not implement access policy 302 (i.e., does not implement access rule 303 or access rule 304) (step 403). In some examples, rule and policy engine 101 may alert user 141 to the conflict indicating access policy 302 cannot be enforced. User 141 may then change business requirement 301 or create an exception to overcome the conflict.

Similarly, in some examples, rule and policy engine 101 may determine the one or more access rules to be inconsistent. That is, the rules may be inconsistent by indicating a condition that cannot possibly be met (e.g., the source may be users in a particular department and the condition may be a role that does not exist in that department). For example, a rule may define a condition for a source that is not possible for that source. In those cases, rule and policy engine 101 may notify user 141 about the inconsistency to indicate the rule will not be enforced. User 141 can then make changes to account for the inconsistency.

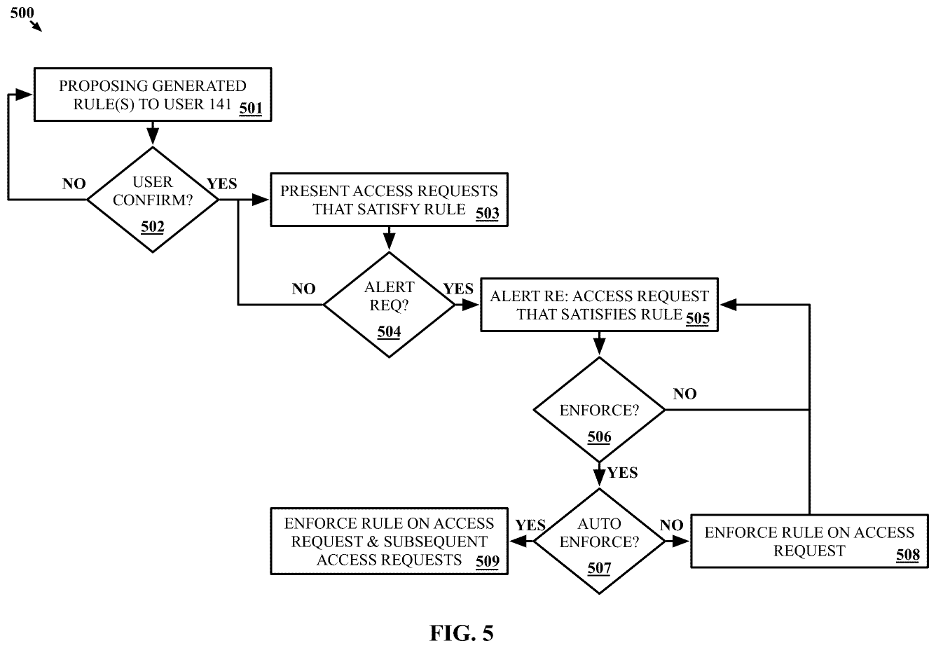

FIG. 5 illustrates operation 500 to control permissions to access resources based on high-level requirements. Operation 500 is an example of how rule and policy engine 101 may handle the lifecycle of an access rule, or rules in some cases (e.g., access rules 303 and 304 generated from business requirement 301), generated from a high-level requirement (step 501). A rule may begin in a proposed stage where rule and policy engine 101 presents the rule to user 141, which is a user tasked with overseeing rules implemented by rule and policy engine 101. The rule may be presented through an interface to rule and policy engine 101 executing in user terminal 104. The rule may be presented in a format that enables user 141 to clearly understand to which source the rule applies, to which destination the source has relation, one or more conditions that must be met, and an action taken when the conditions are satisfied. User 141 can then determine whether the rule is consistent with the high-level policy/requirement for which the rule was generated to enforce. User 141 may be the user that provided the high-level policy to rule and policy engine 101 or another user, such as one not technically versed in rule creation, may have provided the rule in the plain language allowed by rule and policy engine 101 for high-level rules.

The rule remains at the proposed stage until user 141 confirms the rule consistent with the desired high-level policy (step 502). If the user does not confirm the rule is consistent, then rule and policy engine 101 does not advance the rule to the next stage in the lifecycle. Rule and policy engine 101 may discard the rule and await a new rule to be generated that is consistent with the high-level policy. In some examples, user 141 may be able to reword the high-level policy for rule and policy engine 101 to generate an acceptable rule or user 141 may be able to edit the generated rules.

Once the user confirms that a generated rule is consistent with the intentions of the high-level policy, the rule moves to an informational stage of its lifecycle. In the informational stage, rule and policy engine 101 identifies access requests to data environments 102 satisfying the rule and presents those access requests to user 141 without taking the proscribed action (step 503). The access requests may be presented to user 141 individually (e.g., in real time upon being identified) or may be presented in groups (e.g., user 141 may receive a report of identified access requests from the past day). User 141 can review the identified access requests to determine whether the rule is being satisfied by the right type of access requests (e.g., those that the high-level policy intended to capture). Since no action is taken on the access requests during the informational stage, no harm is done if the rule is satisfied by unintended access requests. Instead, user 141 is afforded with another opportunity to change the rule or high-level policy to capture the appropriate access requests.

If user 141 is happy with the results they are presented with during the informational stage, user 141 directs rule and policy engine 101 to advance the rule to an alerting stage (step 504). Should user 141 desire additional information (e.g., due to the sample set of access requests being too low for user 141 to decide), user 141 may allow the rule to remain in the informational stage. Once directed to enter the alerting stage for the rule, rule and policy engine 101 alerts user 141 when an access request is received that satisfies the rule (step 505). The alert notifies user 141 about the access request and indicates the rule has been satisfied, enabling user 141 to decide whether the rule should be enforced. If user 141 does not want the rule to be enforced on the identified access request, user 141 may indicate such to rule and policy engine 101 (step 506). User 141 may explicitly indicate that the rule should not be enforced or rule and policy engine 101 may be configured to not enforce the rule if a response from user 141 is not received within a predefined amount of time. Alternatively, rule and policy engine 101 may be configured to enforce the rule if no response is received within the predefined amount of time. In some examples, the informational stage may be omitted since the alerting stage informs user 141 about rule-satisfying access requests while also providing user 141 with the option to enforce the rule.

If user 141 wants rule and policy engine 101 to enforce the rule, rule and policy engine 101 provides user 141 with the option to auto-enforce the rule (step 507). If user 141 declines to have the rule auto-enforced, rule and policy engine 101 enforces the rule on the access request by performing the action defined by the rule (e.g., blocking the access request) (step 508). The rule remains in the alerting stage and rule and policy engine 101 returns to step 505 to identify and notify user 141 about a subsequent access request that satisfies the rule.

In contrast, if user 141 determines that the rule is ready for auto-enforcement, rule and policy engine 101 moves the rule to the auto-enforced stage of the lifecycle. The auto-enforced stage is the final stage of the rule's lifecycle where the rule reaches maturity and is enforced with other existing rules also at the auto-enforced stage. At the auto-enforced stage, rule and policy engine 101 enforces the rule on the identified access request and continues to enforce the rule on subsequent access requests that rule and policy engine 101 identifies as satisfying the rule (step 509).

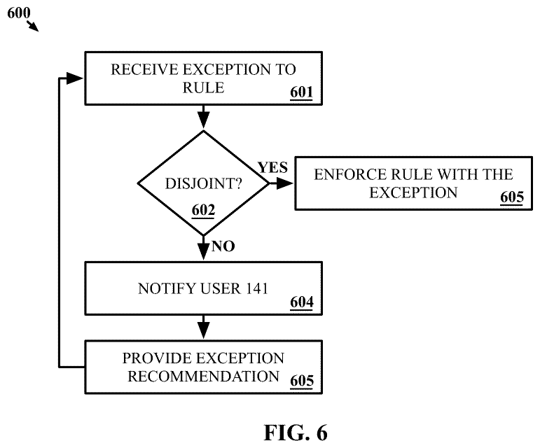

FIG. 6 illustrates operation 600 to control permissions to access resources based on high-level requirements. The rules described above may have exceptions. For example, a rule may prevent employees in one department from accessing certain data in data environments 102. An exception to that rule may allow a particular employee (e.g., the head of the department) to access the data. In operation 600, an exception to a rule being enforced is received by rule and policy engine 101 (step 601). The exception may be one of multiple exceptions to the rule either received at the same time or already enforce. The exception may be received from user 141 or another user. The exception may be first defined in a high-level language like a high-level requirement. The exception must be disjoint from the other exceptions (i.e., has no overlap with other exceptions). If the exception is not disjoint (step 602), then rule and policy engine 101 notifies user 141 that the exception cannot be enforced (step 604). Rule and policy engine 101 may further provide a recommendation for user 141 to change the exception in a manner that is enforceable (step 605). For example, the rule may indicate that everyone in a department can access a particular dataset. An exception may define a subset of employees that can only access the dataset during certain times of day and another exception may define an employee in that subset as not being able to access the dataset at any time. Those two exceptions are not disjoint. Rule and policy engine 101 may recommend that the former exception be modified to remove the employee from the subset so that the latter exception can be implemented.

When rule and policy engine 101 determines that the received exception is disjoint (step 602), rule and policy engine 101 begins enforcing the rule with the exception (step 605). Any future exceptions received at step 601 will, therefore, have to be disjoint from this enforced exception. Although, in some examples, exceptions may be received all at once and rule and policy engine 101 may process them all together to ensure they are disjoint from one another before enforcing the exceptions.

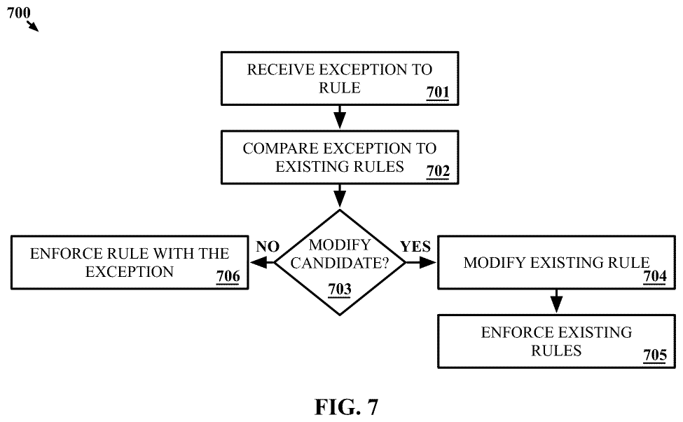

FIG. 7 illustrates operation 700 to control permissions to access resources based on high-level requirements. In operation 700, an exception to a rule is received (step 701). Rule and policy engine 101 compares the exception to existing rules (step 702). An exception can been seen as a rule in itself so it is possible that rules being enforced by rule and policy engine 101 may be satisfied by access requests similar to what will satisfy the exception. Rule and policy engine 101 determines whether there is a candidate in the existing rules that can be modified to continue performing as it already is while also capturing the exception (step 703). For instance, an existing rule may include the same source and destination entities as the exception along with similar conditions and actions. Using the dataset example from above, one of the exceptions allowed access to a dataset by a subset of employees only during certain times of day. Rule and policy engine 101 may identify a rule that allows a different set of employees access to that same data set only during the same times of day. Rule and policy engine 101 may, therefore, determine that rule is a candidate for modification. Rule and policy engine 101 modifies the existing rule accordingly (step 704) and continues to enforce the existing rules after modification (step 705). In the above example, rule and policy engine 101 will modify the existing rule to cover the subset of employees defined by the exception in addition to the different set of employees already included in the rule. If rule and policy engine 101 is unable to find a candidate rule, rule and policy engine 101 enforces the exception in conjunction with the rule for which the exception was defined (step 706).

It should be understood that both operation 600 and operation 700 may be performed on exceptions. For instance, operation 600 may first be performed to ensure the exception does not conflict with other exceptions and then operation 700 may be performed to incorporate the exception into a rule if possible.

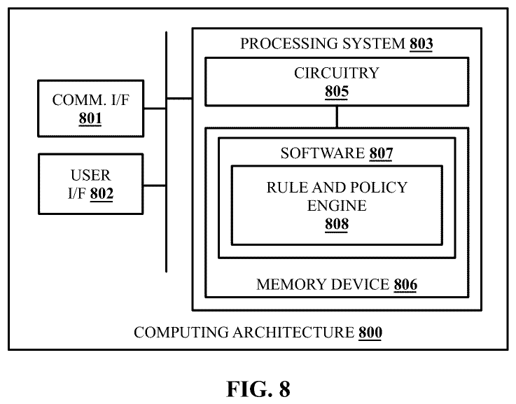

FIG. 8 illustrates computing architecture 800 for controlling permissions to access resources based on high-level requirements. Computing architecture 800 is an example computing architecture for rule and policy engine 101, although rule and policy engine 101 may use alternative configurations. A similar architecture may also be used for other systems described herein (e.g., data environments 102, identity environments 103, and user terminals 104-105), although alternative configurations for those systems may also be used. Computing architecture 800 comprises communication interface 801, user interface 802, and processing system 803. Processing system 803 is linked to communication interface 801 and user interface 802. Processing system 803 includes processing circuitry 805 and memory device 806 that stores operating software 807.

Communication interface 801 comprises components that communicate over communication links, such as network cards, ports, RF transceivers, processing circuitry and software, or some other communication devices. Communication interface 801 may be configured to communicate over metallic, wireless, or optical links. Communication interface 801 may be configured to use TDM, IP, Ethernet, optical networking, wireless protocols, communication signaling, or some other communication format—including combinations thereof.

User interface 802 comprises components that interact with a user. User interface 802 may include a keyboard, display screen, mouse, touch pad, or some other user input/output apparatus. User interface 802 may be omitted in some examples.

Processing circuitry 805 comprises microprocessor and other circuitry that retrieves and executes operating software 807 from memory device 806. Memory device 806 comprises a computer readable storage medium, such as a disk drive, flash drive, data storage circuitry, or some other memory apparatus. In no examples would a computer readable storage medium of memory device 806, or any other computer readable storage medium herein, be considered a transitory form of signal transmission (often referred to as “signals per se”), such as a propagating electrical or electromagnetic signal or carrier wave. Operating software 807 comprises computer programs, firmware, or some other form of machine-readable processing instructions. Operating software 807 includes rule and policy engine 808. Operating software 807 may further include an operating system, utilities, drivers, network interfaces, applications, or some other type of software. When executed by processing circuitry 805, operating software 807 directs processing system 803 to operate computing architecture 800 as described herein.

In particular example, rule and policy engine 808 directs processing system 803 to determine a business requirement for access to data environments and define an access policy that maps to the business requirement. Rule and policy engine 808 further directs processing system 803 to generate one or more rules to implement the access policy and enforce the rules on access requests to the data environments to satisfy the business requirement.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

What is claimed is:

1. A method for enforcing access rules to data environments, the method comprising:
determining a high-level requirement for access to the data environments;
defining an access policy that maps to the high-level requirement;
generating one or more rules to implement the access policy; and
enforcing the one or more rules on access requests to the data environments to satisfy the high-level requirement.

2. The method of claim 1, comprising:
determining the one or more rules do not conflict with one or more existing rules; and
enforcing the one or more rules occurs in response to determining the one or more rules do not conflict with one or more existing rules.

3. The method of claim 2, comprising:
determining a second high-level requirement for access to the data environments;
defining a second access policy that maps to the second high-level requirement;
generating one or more second rules to implement the second access policy; and
in response to determining the one or more second rules conflict with at least one of the one or more existing rules, notifying a user that the second high-level requirement cannot be enforced.

4. The method of claim 1, comprising:
determining a second high-level requirement for access to the data environments;
defining a second access policy that maps to the second high-level requirement;
generating one or more second rules to implement the second access policy; and
in response to identifying an inconsistency in the one or more second rules, notifying a user that the second high-level requirement cannot be enforced.

5. The method of claim 1, wherein each of the one or more rules is defined by a query, one or more conditions, and one or more actions.

6. The method of claim 5, wherein the query indicates a source entity with a relationship to a destination entity, the method comprising:
identifying a subset of the one or more rules having queries with relationships that overlap with existing queries from existing rules; and
identifying conflicting rules in the subset that, when satisfied, result in conflicting actions being taken.

7. The method of claim 6, wherein existing rules are prioritized over the conflicting rules.

8. The method of claim 1, comprising:
prior to enforcing the one or more rules, proposing the one or more rules to a user, wherein the user provides confirmation that the one or more rules appear to satisfy the high-level requirement.

9. The method of claim 8, comprising:
after receiving the confirmation, applying the one or more rules to the access requests and informing the user of a subset of the access requests that would satisfy the one or more rules had the one or more rules been enforced.

10. The method of claim 9, comprising:
after informing the user, receiving direction from the user to enforce the one or more rules on the subset.

11. The method of claim 10, comprising:
after receiving the direction, receiving an instruction from the user to automatically enforce the one or more rules on subsequent requests of the access requests.

12. The method of claim 1, comprising:
receiving exceptions to the one or more rules;
determining at least one exception of the exceptions overlaps with other exceptions; and
notifying a user that the at least one exception cannot be enforced.

13. The method of claim 12, wherein notifying the user comprises:
providing to the user a recommendation for creating a disjoint exception to replace the at least one exception.

14. The method of claim 1, comprising:
receiving exceptions to the one or more rules; and
in response to determining at least one exception of the exceptions can be implemented by modifying existing rules being enforced on the access requests, modifying one or more of the existing rules to implement the at least one exception.

15. The method of claim 1, comprising:
comparing the one or more rules to existing rules being enforced on the access requests; and
in response to determining the existing rules can be modified to enforce the one or more rules rather than adding the one or more rules to the existing rules, modifying the existing rules.

16. An apparatus comprising:
one or more computer readable storage media;
a processing system operatively coupled with the one or more computer readable storage media; and
program instructions stored on the one or more computer readable storage media that, when read and executed by the processing system, direct the apparatus to:
determine a high-level requirement for access to data environments;
define an access policy that maps to the high-level requirement;
generate one or more rules to implement the access policy; and
enforce the one or more rules on access requests to the data environments to satisfy the high-level requirement.

17. The apparatus of claim 16, wherein the program instructions direct the processing system to:
determine a second high-level requirement for access to the data environments;
define a second access policy that maps to the second high-level requirement;
generate one or more second rules to implement the second access policy; and
in response to determining the one or more second rules conflict with at least one of one or more existing rules or the one or more second rules are inconsistent, notify a user that the second high-level requirement cannot be enforced.

18. The apparatus of claim 16, wherein the program instructions direct the processing system to:
prior to enforcing the one or more rules, propose the one or more rules to a user, wherein the user provides confirmation that the one or more rules appear to satisfy the high-level requirement.

19. The apparatus of claim 16,
receive exceptions to the one or more rules;
in response to a determination that at least one exception of the exceptions overlaps with other exceptions, notify a user that the at least one exception cannot be enforced;
in response to another determination that at least one other exception of the exceptions can be implemented by modifying existing rules being enforced on the access requests, modify one or more of the existing rules to implement the at least one other exception.

20. A method enforcing access rules to data environments, the method comprising:
receiving a business requirement from a user, wherein the business requirement is defined in natural language;
parsing the natural language to generate an access policy covering the business requirement;
generating rules corresponding to one or more identity environments and a subset of the data environments that will implement the rules; and
enforcing the rules via the one or more identity environments and the subset of the data environments.
